(19) United States
(12) Patent Application Publication
(10) Pub. No.: US 2005/0172553 A1
(43) Pub. Date: Aug. 11, 2005

(54) Device for the generation of hydrogen

(76) Inventors: Nicolas Zartenar, Holzkirchen (DE); Peter Britz, Egmating (DE); Klaus Wanninger, Kolbermoor (DE)

Correspondence Address: THE WEBB LAW FIRM, P.C., 700 KOPPERS BUILDING, 436 SEVENTH AVENUE, PITTSBURGH, PA, 15219, US

(21) Appl. No.: 10/508,881

(22) PCT Filed: Mar. 24, 2003
(86) PCT No.: PCT/DE03/00968

(51) Int. Cl. B01J 8/04

(52) U.S. Cl. 48/127.9; 48/128; 422/198; 422/191; 422/211

(57) ABSTRACT

The invention relates to a device for the generation of hydrogen, comprising; (a) a heated steam reformation stage, with a reformer catalyst for the conversion of gaseous or vaporizable hydrocarbons and water into hydrogen, carbon monoxide and further reformation products; (b) at least one stage, arranged after the steam reformation stage, for the catalytic conversion of the mixture of hydrogen, carbon monoxide and excess steam emanating from the steam reformation stage (shift step); and (c) a fine purification stage after the conversion stages for the catalytic reduction of the residual carbon monoxide content in the conversion products. The invention is characterized in that the conversion stages and the fine purification stage are each embodied as hollow bodies with an annular chamber for housing the corresponding catalyst.

The invention relates to a device for the generation of hydrogen with a steam reformation stage, at least one conversion stage, and a fine purification stage.

Such devices are known, for example, from DE 100 57 537 A1. In combination with, for example, a polymer membrane (PEM) fuel cell, it serves for power and thermal generation, whereas the hydrogen obtained in the reformation stage from gaseous or vaporizable hydrocarbons is converted in the fuel cell in the known manner. Such compositions are used both in stationary and in mobile areas (in automobiles).

Generally, several catalyst stages are arranged downstream of the reformation stage for the purpose of gas purification, which reduce the concentration of the carbon monoxide that is harmful for the fuel cell at different temperature levels. For example, in a known embodiment of the reformation stage, a so-called high-temperature conversion stage (high-temperature shift step; HTS stage) follows the reformation stage, which ensures a substantial reduction of the carbon monoxide concentration at a temperature level of approximately 350 to 400° C. The shift reaction is an exothermal balance reaction, which is why a certain concentration of carbon monoxide still exists in the gas mixture at the temperatures of the high-temperature shift step. A further reduction of the carbon monoxide concentration may subsequently occur in a so-called low-temperature conversion stage (low-temperature shift step; LTS stage) at a temperature of about 200° C. In order to reduce the carbon monoxide content to a degree suitable for the fuel cell, a fine purification stage is usually arranged downstream, in which the residual carbon monoxide content is reduced (a) either by means of selective oxidation (SelOx stage), or (b) by means of selective methanation to a value of <100 ppm.

The carrier catalysts used in the high-temperature, low-temperature, and fine purification stages, between which heat exchangers may be arranged for the purpose of adjusting the required temperature ranges, are embodied in the currently used gas generation systems as fully cylindrical honeycomb bodies, through which the reformer gas flows in longitudinal direction, or through which the gases generated in the shift step, or in the fine purification stage, respectively, flow.

EP 0 913 357 A1 describes a reformation device with a catalyst unit capable of generating hydrogen from a reactant mixture containing an organic compound, or carbon monoxide, which also contains an electrical heating device. The catalyst unit is embodied as a complete honeycomb structure, and may be used for steam reformation, for partial oxidation and decomposition, and/or for the carbon monoxide shift reaction, and/or for the selective oxidation of carbon monoxide.

DE 199 21 420 A1 describes a primary reformer for the use in methanol, ammonia, or hydrogen generation with the use of tube heating. The reformer may be embodied as a double tube with concentric arrangement of the steam/feed input, the input of an oxidation carrier, and the output of the reformed synthetic gas. Only a one-stage primary reformer is described for performing the endothermic reactions without any devices arranged downstream for performing the exothermic reactions.

A device for the reformation of educts containing hydrocarbons with a reformation reactor, which at least partially contains metal honeycomb bodies with a catalyst coating, is known from DE 197 21 630 C1. A radiation burner envelopes the two-part reformation reactor consisting of an interior tube reactor, and an annular gap reactor surrounding the same at a distance, whereas the flue gas is guided to the educt gas in the tube reactor within the counter flow in the gap between the interior tube reactor and the annular gap reactor. This device is merely a one-stage device for performing an endothermic reformation reaction. There are no indications on any downstream exothermic stages.

A method and a device for the conversion of fluid, vaporizable, or gaseous hydrocarbons for the generation of synthetic gases containing hydrogen for the use in fuel cells is known from DE 101 09 983 A1, whereas the chemical conversion of the educts occurs at the surface of a material that can be electrically heated. The conversion occurs at a porous interior tube that is coated with a catalyst. The conversion is an endothermic reformation reaction. There are no indications on any devices for performing any exothermic reactions.

DE 39 40 700 A1 relates to a catalytic reactor with a coaxial double-tube construction having a reaction fluid inlet and a reaction fluid outlet at the end of the reactor. The other, closed end of the exterior reactor protrudes into a heating container. The reaction fluid is then fed through an annular chamber that is filled with the catalyst, and subsequently discharged through the interior tube. It is therefore a one-stage reactor for endothermic reactions, particularly a steam reformation reactor for the production of hydrogen. There is no mention of any downstream reactors, in which an exothermic reaction takes place.

A device for the production of hydrogen by means of water steam reformation in a solid-state catalyst is known from DE 69420604 T2 (EP 0 615 949 B1). Hydrogen is separated and collected by means of a partition that is selectively permeable for hydrogen. The device contains an exterior cylinder, an intermediate cylinder, and an interior cylinder, between which annular chambers are embodied. A burner is located in the interior cylinder. The device is used for performing an endothermic reaction. There are no indications of any exothermic reactions.

DE 198 32 386 A1 describes a reformation reactor, particularly for the water steam reformation of methanol in a fuel cell vehicle, which contains a reformation stage, in which an endothermic reformation reaction is performed. A CO shift step is performed subsequent to the reformation stage. Further, a catalytic burner unit is provided, which contains a heating range in thermal contact with the reformer stage, and a cooling range arranged upstream from the heating range, in thermal contact with the CO shift step, having a low burning catalyst activity as opposed to the heating range. The fuel gas is guided in the counter flow to the reformation educts flowing through the CO shift step, and to the source material mixture flowing through the reformer stage through a cooling range, and through the subsequent heating range. There are no indications with regard to the embodiment of the catalyst for the CO shift reaction.

DE 197 13 242 A1 describes a reformation reactor for the water steam reformation of methanol, which has a two-stage design with a first reactor stage on the input side, and a second reactor stage connected directly to the same in the gas flow direction on the output side, whereas the two reactor stage is housed in a mutual reactor housing, and filled with a continuous catalyst feed material. One of the two reactor stages is heated, while the other reactor stage remains unheated. The unheated second stage can act as the shift step. Additionally, the heat of the exothermic shift reaction may support the endothermic methanol reformation. The catalyst material is present in the form of feed material.

DE 196 24 433 C1 relates to a reformation reactor, particularly for the water steam reformation of methanol, with three serially arranged reactor stages, of which each is loaded with a catalyst pellet feed material. The center reactor stage is maintained at a temperature suitable for the performance of the reformation reaction by means of heating, while the other two reactor stages remain unheated. A shift reaction takes place in the unheated reactor stage on the output side. The catalyst pellets can be damaged by abrasion due to agitations, as they occur with the use in automobiles during driving operation. Further, the catalyst pellets have a higher flow resistance, than a honeycomb body.

DE 100 57 420 A1 describes a multi-stage shift reactor for the reduction of the carbon monoxide content in a gas mixture flow that is rich in hydrogen, which contains at least two catalyst carrier bodies successively arranged in the flow direction having a honeycomb structure with channels. The catalyst carrier bodies are embodied as complete cylinders. Further, a device for the partial oxidation of a gas mixture flow containing hydrocarbon is also described.

If the catalysts used in the shift step are present in the form of full bodies, it has been found that it is a problem for gas purification that a radial temperature drop occurs from the interior to the exterior due to the exothermic shift reaction, which may be approximately 60 to 70° C. This leads to the purity of the gas being dependent on which cross sectional range it currently flows through. Particularly, due to the displacement of balance, the CO content of the gas mixture is higher at the warmer center of the honeycomb body, than at the cooler circumference.

The invention is therefore based on the task of ensuring in a most simple manner with regard to the construction of the device of the above named type that the gas mixture (reformation gas) exiting the reformation stage is subjected to purification (reduction of the CO content) that is as uniform and complete as possible, regardless of which (radial) range of the catalyst stage(s) it flows through after reformation.

This task is solved according to the invention with the use of a device that contains (a) a heated steam reformation stage for the conversion from gaseous or vaporizable hydrocarbons and water in hydrogen, carbon monoxide and additional reformer products; (b) at least one stage to the catalytic conversion of the mixture made up of carbon monoxide and excessive water steam (shift step) that is arranged downstream of the steam reformation stage; and (c) one fine purification stage for the catalytic reduction of the residual carbon monoxide content of the conversion products that is arranged downstream of the conversion stage(s); this device is characterized in that the conversion stage(s) and the fine purification stage are each embodied as a hollow body with an annular chamber for housing the corresponding catalysts.

The steam reformation stage is preferably embodied as a hollow body, preferably as a hollow cylinder, with a shell chamber, preferably an annular chamber, for housing the reformer catalysts; a heating device being arranged in the shell chamber. The heating device is preferably embodied as a burner. Preferably, the annular chamber of the (first) conversion stage directly connects to the annular chamber of the steam reformation stage, and the annular chamber of the fine purification stage directly connects to the annular chamber of the (last) conversion stage to form a complete annular chamber over all the stages.

An endothermic reaction according to the equation
nH₂O+CₙH₂ₙ₊₂ₙ₊₂ [symbol] 3n+2H₂+nCO
occurs in the steam reformation stage (a). The temperature in the steam reformation stage is generally approximately 500 to 800° C., preferably approximately 600° C. The preferred hydrocarbon is methane (n=1); however, higher, still vaporizable hydrocarbons that are within the benzene range (n=6 to 8) may also be used. Instead of hydrocarbons, other organic compounds may also be used, such as methanol. In case of excess water steam part of the carbon monoxide will be converted into carbon dioxide in the reformation stage. The term “additional reformer products” means carbon dioxide, and not converted hydrocarbons.

The following exothermic reaction occurs in the stage of catalytic conversion (b) (shift step):
CO+H₂O [symbol] CO₂+H₂.
The shift reaction is usually performed in a high-temperature shift step at temperatures within a range of 230 to 300° C., and in a separate low-temperature shift step of approximately 250 to 270° C. The CO content after the first stage is about 1.5 to 3.0% in volume, after the second stage about 0.3 to 0.6% in volume. In the high-temperature shift step, the following catalysts may be used: Fe₂O₃/Cr₂O₃, CuO/Cr₂O₃, CuO/ZnO (Cr₂O₃), Pt on the oxides of tetravalent metals (TiO₂, ZrO₂). The following may be used as the catalysts in the low-temperature shift step: Pt on TiO₂, and/or ZrO₂, and/or CrO₂ (generally tetravalent metals), and/or CuO/ZnO.

The molar ratio H O/C-proportion at the beginning of the reformation stage is about 3 to 4:1, particularly 2.8 to 4:1. Carbonization generally occurs at a ratio of below 2.8:1. Excess steam is also necessary due to the adjustment of balance. The high-temperature and low-temperature shift steps may also be combined to one stage.

As the gas mixture still contains some carbon monoxide at the exit of the low-temperature shift step, a fine purification stage (c) is arranged downstream. The fine purification can occur in accordance with two methods:
1.) selective oxidation of the CO in the hydrogen flow (SelOx-stage) with a Pt or Ru catalyst, whereas only very little air is added, according to the reaction equation:
   2CO+O₂→2CO₂
2.) selective methanation of the CO according to the reaction equation:
   CO+3H₂ [symbol] CH₄+H₂O

According to both reactions, which are both exothermic, the carbon monoxide content is generally reduced to <100 ppm. The temperature in the fine purification stage (c) is approximately 200 to 250° C.

The methane formed in the reaction (2) does not interfere with the use in a fuel cell. The CH₄ content is approximately 1 to 4% in volume, including the methane not converted in the reformation stage.

As applicable, both the shift step(s) and the fine purification stage will be referred to in short as “catalyst stage” in the following description.

The hollow bodies used in the individual steps are preferably hollow cylinders. However, hollow bodies with a, for example, triangular, rectangular, or polygonal hollow cross section may also be used.

Due to the fact that the catalyst stages arranged downstream of the reformation stage are preferably each embodied as a hollow cylinder with an annular chamber, an essentially isothermal, radial temperature profile is formed across the through flow cross section of the individual catalyst stages, as the distance between the edge areas is significantly smaller as compared to that of the full cylinder catalyst body with an equal flow cross sectional surface.

The temperature distribution in the hollow cylindrical catalyst stages is more favorable in radial direction, i.e. the temperature gradient is essentially smaller, than with traditional full cylinder honeycombs. Furthermore, as only low temperature windows are permissible for the operation of the fuel cell in the catalyst stages, since otherwise the carbon monoxide proportion would rise too high, this particular catalyst configuration is particularly well suited.

A further advantage of the device according to the invention is that the hollow cylinders of the successive stages directly neighbor each other so that no separate feed or discharge lines, or bypass devices are necessary between the individual stages.

A burner is preferably used as the heating device in the steam reformation stage, which is appropriately arranged in the center of the hollow cylinder of the reformation stage.

Preferably the cross section thickness of the hollow cylindrical catalyst body is about 2 to 20% of the exterior diameter of the hollow cylinder.

The catalyst in at least one of the annular chambers of the individual stages is preferably arranged in a honeycomb structure. For this purpose, for example, ceramic honeycombs may be used. The catalysts are, however, preferably arranged on a flow channel limiting (corrugated) metal foil.

For the further equalization of the radial temperature profile of the hollow cylindrical catalyst stages, and for improving the material exchange within the hollow cylinder, perforations are preferably provided in the flow channel limiting metal foil between the individual flow channels. This has the effect of allowing the gas mixtures in the individual catalyst stages to flow not only axially, but also laterally through the catalyst stages for the purpose of balancing the temperature to a certain degree. The perforations cause an increase in turbulence so that the gas mixtures are well mixed in the interior area of the hollow cylinder with the gas mixtures in its exterior area, which have a somewhat different composition.

The main direction of flow of hydrogen and of the reformer products within the hollow body is preferably essentially oriented parallel to its axis.

A particularly preferred embodiment further exists in that at least one flow channel is provided in the interior of the hollow body (bodies) of the catalyst stage(s), which preferably represents an annular chamber. This flow channel serves for feeding and preheating the hydrocarbons required for reformation in the opposite direction of the flow of the gaseous products coming from the catalyst stage(s). This heat exchange with the hydrocarbons causes the exothermic heat generated in the additional catalyst stage(s) to be evenly discharged so that the temperature drop is reduced also in axial direction. The flow channel may also represent an annular chamber.

Preferably an indirect heat exchanger is provided at least between the conversion stage(s) and the steam reformation stage, and possibly also between the last conversion stage and the fine purification stage, through which the water required for the steam reformation is guided in counter flow of the gaseous products coming from the conversion stage(s) and possibly also from the fine purification stage.

The device according to the invention, including some advantageous further embodiments, is explained as follows using the illustrated drawings of one embodiment example.

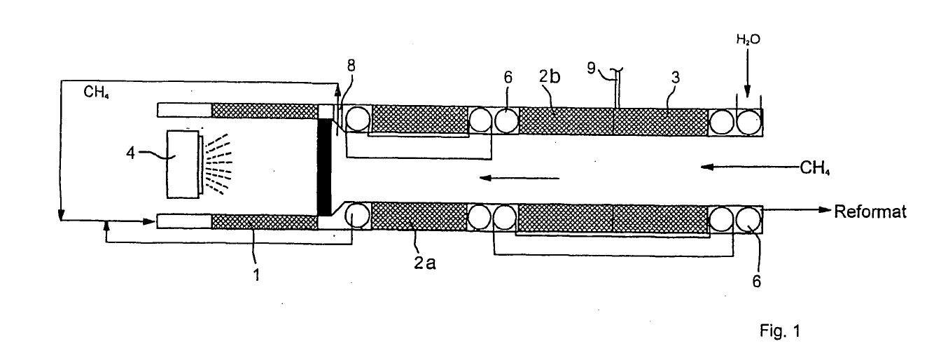

FIG. 1 shows the device according to the invention in a section (without circumferential edges) as an elementary drawing. It is comprised of the reformation stage 1 for the conversion of gaseous or vaporizable hydrocarbons (particularly methane) with water steam to hydrogen, carbon monoxide, and to additional reformer products (reformate), whereas the reformation stage of this preferred embodiment is embodied in the shape of a hollow cylinder, and a reformer burner 4 (such as a gas surface burner) is centrically arranged therein (the heat development is indicated by a dashed line). For the chemical conditioning, i.e. for reducing the carbon monoxide content of the reformer products, three catalyst stages are arranged downstream of the reformation stage 1, whereas the catalyst stage 2a represents a high-temperature shift step (HTS stage), stage 2b represents a low-temperature shift step (LTS stage), and stage 3 represents a gas purification stage (either a SelOx or a methanation stage).

When using a SelOx stage, in which the residual carbon monoxide is selectively oxidized under air supply, the equipment with an air supply 9 (illustrated schematically) that is evenly distributed across the circumference of the annular chamber is preferably provided, whereas the same is preferably embodied as an annular manifold with distributed discharge nozzles.

A flow channel 5 is provided in the hollow space of the hollow cylindrical catalyst stages 2a, 2b, 3. The gaseous or vaporizable, respectively, hydrocarbons are guided through the flow channel 5 in the direction of the arrow for the purpose of preheating in the opposite direction of the flow of the reformer products, i.e. the heat generated at the catalyst stages 2a, 2b, and 3 during the exothermic reactions is directly used in order to heat the reformer educts. The design of the flow channel being that of an annular channel (not illustrated) has the advantage that the hydrocarbons are heated evenly.

In order to separate the hollow cylindrical reformer chamber from the flow channel 5, a partition 7 is provided, i.e. the hydrocarbon gas enters via a schematically illustrated connection 8 into the reformation stage 1.

In order to finally also preheat the water required for the reformation reaction, heat exchangers 6 (such as a helix tube heat exchanger) are provided between the stages 1 and 2a, between the stages. 2a and 2b, and at the end of stage 3, through which process water flows, on one hand, and which are in thermal contact with the flow channel 5, on the other hand. An additional heat exchanger may be provided between the stages 2b and 3.

The problem of the radially uneven temperature distribution is essentially solved by means of the above described embodiments. However, it has been found that another problem is that a non-equalization of the temperature profile, and therefore a degradation of the gas quality results within the conversion stage(s), as well as within the fine purification stage in axial direction due to the exothermic shift reaction, or with the selective oxidation or methanation reaction, respectively. In order to solve this problem, it is therefore recommended to provide a flow guide enclosure that envelopes the conversion stage(s) from the exterior, for a cooling medium for the cooling of the conversion stage(s), whereas the cooling medium preferably is water or hydrocarbon, which can be fed to the steam reformation stage in the form of steam. The use of a flow guide enclosure is not limited to the above described device according to the invention, but can also be used in known devices, in which the catalyst stage(s) is (are) embodied as complete bodies, in order to minimize the axial temperature gradient.

The heat generated by the conversion of carbon monoxide into hydrocarbon is discharged by the cooling medium. As described in further detail in the following, the surface of the honeycomb body on the shift step(s) (or a respective shell), on one hand, and the wall of the flow guide enclosure, on the other hand, form the sides of the channel for the cooling medium, which simultaneously has the advantage that the heat emanated in the shift step(s), can be selectively discharged, is not dissipated into the atmosphere uselessly. The cooling of the exterior shell results in an equalization of the axial temperature profile, i.e. by means of the combination of the cooling of the exterior shell and the design of the catalyst as a hollow cylinder, a constant ratio between carbon monoxide and hydrocarbon is obtained at each location of the shift step(s).

Preferably, the flow guide enclosure contains input and output connections for the cooling medium, and is optionally designed in the equal or counter flow of the through flow direction within the conversion stage(s). If a strong development of heat is expected on the input side of the first shift step, an equal flow operation will abet the cooling effect, and therefore an operation in the direction of an equal axial temperature distribution in the shift step due to a larger thermodynamic temperature distance of the media involved. The same is true in the reverse case of a counter flow.

Furthermore, for the purpose of the optional preheating of the water and/or the hydrocarbons fed to the reformation stage, the same may be fed to the flow guide enclose as the cooling medium, for which purpose the flow guide enclosure is preferably hydraulically connected to the educt input of the reformation stage on the discharge connection side.

Furthermore, a control valve may be provided as an option at the input and/or output connections of the flow guide enclosure for the mass adjustment of the flow of the cooling medium. Together with a temperature sensor that is arranged downstream of the catalyst stage(s) in the flow path of hydrogen and the remaining reformer products, and an upstream control unit, a water flow adjustment of the cooling medium that is oriented on the output temperature of the mixture coming from the catalyst stage, which, as mentioned above, may also be formed by the reformer educts.

The embodiment explained last is described as follows using the illustrated drawing of an embodiment example. It shows:

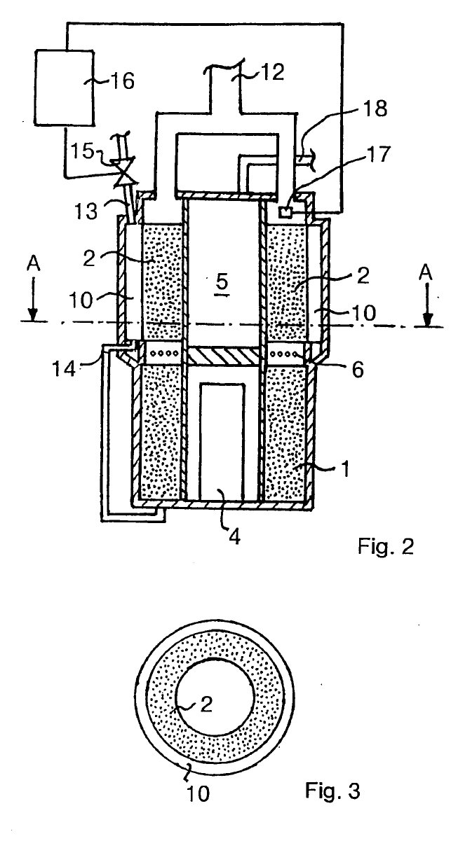

FIG. 2 in a sectional view an embodiment according to the invention with a flow enclosure for the cooling of the exterior shell of the shift step.

FIG. 3 a sectional view across the device according to FIG. 2 along a line A-A.

FIG. 2 shows the embodiment according to the invention in a longitudinal section. This device contains a reformation stage 1, which is embodied as a hollow cylindrical body, in the free center of which a gas burner 4 is arranged for generating the heat required for reformation. A conversion stage 2 (one-stage) embodied as a hollow cylinder, and possibly a (not illustrated) fine purification stage are arranged downstream of the reformation stage 1. The generation of hydrogen occurs in accordance with the following steps. First, hydrocarbon and water steam are added to the reformation stage 1, and converted there to hydrogen, carbon monoxide (and a little carbon dioxide) with the aid of the head emanated from the gas burner 4 (temperature is about 800° C.). At the exit of the reformation stage 1, the product gas is cooled down to a temperature suitable for the catalytic shift reaction for reducing the carbon monoxide proportion with the aid of the heat exchanger 6. Subsequently, the conversion of the carbon monoxide into carbon dioxide is performed in the shift step 2 at a temperature within a range of approximately 250 to 300° C. After the shift step 2, of which an additional fine purification stage may be arranged downstream, as mentioned, depending on the required purity of the product gas, the practically carbon monoxide-free gas will reach the fuel cell via the product gas line 12 (not illustrated).

For the purpose of equalization of the axial temperature profile within the shift step 2, a flow guide enclosure 10 that envelopes the same from the exterior is provided for a cooling medium. As shown in particular in FIG. 3, the flow guide enclosure 10 is embodied to some extent as a cylindrical shell enveloping the catalyst stage 2, which limits a concentric annular gap through which the cooling medium flows. Of course, other embodiments of the enclosure are also realizable. It is essential that a sufficient heat discharge is ensured from the exterior circumference of the catalyst stage 2. For this purpose, for example, even a helix tube enveloping the catalyst stage 2 is suitable, which, generally speaking, is the flow guide enclosure 10. FIG. 2 further shows that the flow guide enclosure 10 has input 13 and output 14 connections for the cooling medium, and is embodied so that the cooling medium can flow through it in counter flow direction to the flow through direction within the catalyst stage 2. Preferably, water is used as the cooling medium, which is required for the reformer process anyway, and which slightly preheated advantageously reaches the entrance of the reformation stage 1 through the flow guide enclosure 1 according to the invention. If necessary, the hydrocarbon gas required for the reformation process may also be fed to the flow guide enclosure 10 via the supply connection 13 together with the water, and preheated there.

A control valve 15 is preferably provided at the supply connection 13 in the illustrated embodiment example for the mass flow adjustment of the cooling medium, which is in contact with a control device 16 arranged upstream in a line. At the same time, a temperature sensor 17 is arranged downstream of the catalyst stage 2 in the flow path of the hydrogen of the residual reformer products, which in turn is connected to the control valve 15 of the mass flow adjustment of the cooling medium via the upstream control device 16. In this manner the cooling performance can be varied to a certain degree at the shell surface of the catalyst stage 2 in dependency of the product gas discharge temperature.

Finally, an additional coolant channel 5 is arranged preferably in the interior of the hollow cylindrically embodied catalyst stage 2, through which preferably and optionally water and/or hydrocarbon gas can flow. The supply of the cooling medium occurs via the connection line 18. The discharge line is not illustrated, because it is easily conceivable.

1-21. (canceled)

22. A device for the generation of hydrogen, comprising:
a. a heated steam reformation stage with a reformer catalyst for converting gaseous or vaporizable hydrocarbons and water into hydrogen, carbon monoxide and further reformation products, wherein the steam reformation stage is embodied as a hollow body, with a shell chamber embodied as an annular chamber for housing a reformer catalyst, and a heating device that is arranged in the shell chamber;
b. at least one stage that is arranged downstream of the steam reformation stage for catalytic conversion of the mixture of hydrogen, carbon monoxide, and excess water steam (shift step) emanating from the steam reformation stage, wherein the conversion stages are embodied as a hollow body with an annular chamber for housing a corresponding catalyst; and
c. a fine purification stage that is arranged downstream of the conversion stages for catalytic reduction of the residual carbon monoxide content of the conversion products, wherein the fine purification stage is embodied as a hollow body with an annular chamber for housing the corresponding catalyst, and wherein the annular chamber of the fine purification stage directly connects to the annular chamber of the conversion stage on the fine purification stage side,
wherein the annular chamber of the conversion stage on the steam reformation stage side directly connects to the annular chamber of the steam reformation stage to form a complete annular chamber of all the stages.

23. The device according to claim 22, wherein the heating device is embodied as a burner.

24. The device according to claim 22, wherein the cross sectional thickness of the complete annular chamber is approximately 2 to 20% of the exterior diameter of the hollow body.

25. The device according to claim 22, wherein the catalyst is arranged in at least one of the annular chambers in a honeycomb structure, preferably arranged on a flow channel limiting corrugated metal foil.

26. The device according to claim 25, wherein perforations are provided between the flow channels for improving the material exchange.

27. The device according to claim 22, wherein at least one flow channel is provided in the interior of the hollow body (bodies).

28. The device according to claim 22, wherein the main direction of flow of hydrogen and of the reformer products within the hollow body is preferably essentially oriented parallel to its axis.

29. The device according to claim 28, wherein the flow channel represents an annular chamber.

30. The device according to claim 28, wherein the flow channel is embodied for feeding and preheating the hydrocarbons in the opposite direction of the flow of the gaseous products coming from the conversion stages and the fine purification stage.

31. The device according to claim 22, wherein an indirect heat exchanger is provided at least between the conversion stages and the steam reformation stage, and possibly also between the conversion stage and the fine purification stage, through which the water required for the steam reformation is guided in counter flow of the gaseous products coming from the conversion stages and possibly also from the fine purification stage.

32. The device according to claim 22, wherein the fine purification stage is embodied optionally as a selective oxidation stage (SelOx stage), or as a methanation stage.

33. The device according to claim 32, wherein the SelOx stage is equipped with an air supply that is evenly arranged across the circumference of the annular chamber of the fine purification stage.

34. The device according to claim 33, wherein the air supply is embodied as an annular manifold with distributed discharge nozzles.

35. The device according to claim 22, wherein a flow guide enclosure that envelopes the conversion stages from the exterior, for a cooling medium for the cooling of the conversion stages, wherein the cooling medium preferably is water or hydrocarbons, which can be fed to the steam reformation stage in the form of steam.

36. The device according to claim 35, wherein the flow guide enclosure contains input and output connections for the cooling medium, and is optionally designed in the equal or counter flow of the through flow direction within the conversion stages.

37. The device according to claim 35, wherein the flow guide enclosure is hydraulically connected on the discharge connection side to the reformation stage on the educt input side.

38. The device according to claim 35, wherein a control valve is provided as an option at the input and/or output connections of the flow guide enclosure for the mass adjustment of the flow of the cooling medium.

39. The device according to claim 22, wherein at least one temperature sensor is arranged at the downstream end of the annular chamber of the conversion stages, which is connected to the control valve for the mass adjustment of the flow of the cooling medium via an upstream control unit.

40. The device according to claim 22, wherein an additional cooling medium channel is arranged in the interior of the hollow cylindrically embodied conversion stages, through which preferably and optionally water and/or the hydrocarbons can flow.
